(19) United States
(12) Patent Application Publication
(10) Pub. No.: US 2015/0006133 A1
(43) Pub. Date: Jan. 1, 2015

(54) State Space System Simulator Utilizing Bi-quadratic Blocks to Simulate Lightly Damped Resonances

(71) Applicant: Agilent Technologies, Inc., Loveland, CO (US)

(72) Inventors: Daniel Y. Abramovitch, Palo Alto, CA (US); Eric S. Johnstone, Redwood City, CA (US)

(73) Assignee: Agilent Technologies, Inc., Loveland, CO (US)

(21) Appl. No.: 14/470,870

(22) Filed: Aug. 27, 2014

Related U.S. Application Data
(63) Continuation of application No. PCT/US12/27149, filed on Feb. 29, 2012.

(51) Int. Cl. G06F 17/50

(52) U.S. Cl. CPC G06F 17/5009
USPC 703/2

(57) ABSTRACT

A method for operating a data processing system to simulate a physical system is disclosed. The physical system receives a time-varying input and generates a time-varying output. A model of the physical system is provided. The model depends on values of the time-varying input and an internal state in the physical system, the internal state is not directly measurable. The model includes a bi-quad component that models a resonance or anti-resonance of the physical system. For each of a plurality of time points, a current input value for the time-varying input is received. An internal state vector having a value of the internal state at a current time point as one component thereof is computed and computing an estimate of a system output at that time point, the system output being directly measurable. In one aspect of the invention, the internal state vector depends on a previous value of the internal state vector and the current input value.

### CROSS REFERENCE TO RELATED APPLICATIONS

This is a continuation of International Application PCT/US 12/27149 filed on 29 Feb. 2012.

### BACKGROUND

One class of computer-based simulators utilizes a mathematical model of a physical system to simulate the operation of the system. The system typically receives inputs representing real-world signals or stimuli and generates one or more outputs. In many cases, the system also has internal states that cannot be measured directly, but whose values are of interest and can be inferred from the system model.

In many cases, the simulator utilizes a model that has a number of parameters that are optimized such that the model's predictions of the system output for various inputs is as close as possible to the experimentally-determined outputs for those inputs. In general, there are a large number of models that can be used to represent any given system; hence, some criterion is needed to select between the models. One such criterion is the sensitivity of the model parameters to noise in the experimental measurements used to determine those parameters. If the model parameters vary significantly with small noise errors, the model is not likely to represent the system accurately unless noise-free measurements are available, which is seldom the case.

The simulator can be used to accomplish a number of goals. A simulator can be used to predict the output of the system for a particular input. The output can then be used in a feedback loop to control the inputs of the system. A simulator can be used together with actual measurements of the output of the system to improve the accuracy of such measurements when the measurements are subject to errors introduced by noise or other distortions. In addition, a simulator can also be used to provide an estimate of one or more of the internal states of the system by using the measured outputs and known inputs. Furthermore, the simulator model can be used as the starting point for the design of a controller or a filter.

As noted above, the simulator depends on a model for the system. One class of models that, in principle, allows the simulator to estimate the internal states of the system as well as simulate the outputs is referred to as state space models. These models explicitly provide information on one or more internal states. Unfortunately, these models perform poorly when the system being modeled has lightly damped resonances, because the model parameters tend to be very sensitive to any noise in the measurements used to determine the parameters.

Consider a system that receives energy in the form of a signal having an amplitude that is a function of frequency and produces an output that has an amplitude as a function of frequency. The system will be said to have a resonance if the output amplitude is substantially greater over some band of frequencies than at other frequencies. Alternatively, the system has a resonance if the system stores energy when the input signal has energy in a band of frequencies. Such systems typically store energy by transferring energy from one mode to another, i.e., from one state to another. Small driving forces in the band of frequencies in question can lead to large amplitude changes in the output signal if the system is lightly damped, since the damping energy loss is insufficient to prevent part of the driving energy from being stored in the oscillating mode. Conversely, a system can be said to have an anti-resonance if the output amplitude is substantially reduced in some band of frequencies compared to the surrounding bands. Such a system would be thought of as dissipating energy put into it at frequencies close to the anti-resonance.

Consider a model for such a system in which the model's output is the output amplitude as a function of frequency that is obtained with an input signal having a known amplitude as a function of frequency. The model is a mathematical function that must be able to generate large swings in the amplitude of the output signal as a function of frequency. For example, if the function is represented as a Fourier series over the entire range of frequencies, the series must include components at very high frequencies to enable the function to change amplitude quickly as a function of frequency. Because the system is lightly damped, the high frequency components can be excited by energy that is outside the band of the resonance that is being modeled. Accordingly, any high frequency noise in the input signal or its mathematical representation in the model will lead to high frequency artifacts in the output signal.

In addition, the internal computations that generate the output from the model are also subject to round-off error problems. Finally, the approximations used in converting a continuous model to a discrete model that can be implemented on a computer introduce other distortions that are amplified. For example, the model may require that a derivative of the input or some internal variable be computed. In the discrete approximation, the derivative is computed by finite differences that will be in error. As a result, such models fail to provide accurate simulations.

State space models of systems characterized by a number of lightly damped resonances are characterized by analogous problems. To model the resonances, a function that couples energy from a wide band of frequencies is typically utilized. For example, a function represented by a ratio of high order polynomials can simulate a number of resonances and anti-resonances. The band of frequencies is typically much larger than the band of frequencies that characterize a single resonance. As a result, any form of noise in the input or significant round-off error during the computations results in outputs that vary widely as a function of frequency and fail to accurately represent the system.

Lightly damped physical structures are an almost universal phenomena. Everything is flexible if one measures it finely enough. Furthermore, lowering the weight of an actuator or a physical structure to make it faster or easier to transport (for example into space) will leave less material to stiffen that structure. Even structures which would seem stiff are flexible at high enough frequencies and with precise enough measurements. Examples of such systems are found in data storage (hard disk drives and optical drives). robotics (such as the Space Shuttle and ISS Robot Arms), and nanoscale measurements (such as Atomic Force Microscopes). For such systems, precise modeling of large numbers of resonances and anti-resonances in state space has been limited, in large part because the numerical properties of these state space models present problems when large numbers of lightly damped dynamics were added. Accordingly, it would be advantageous to provide a state space model that can accommodate large numbers of lightly damped dynamics without being limited by the computational properties of prior art state space models.

### SUMMARY

The present invention includes a method for operating a data processing system to simulate a physical system and an apparatus that emulates that physical system using the method. The physical system receives a time-varying input and generates a time-varying output. A model of the physical system is provided. The model depends on values of the time-varying input and an internal state in the physical system, the internal state not is directly measurable. The model includes a bi-quad component that models a resonance or anti-resonance of the physical system. For each of a plurality of time points, a current input value for the time-varying input is received. An internal state vector having a value of the internal state at a current time point as one component thereof is computed. The model computes an estimate of a system output at that time point, the system output being directly measurable. In one aspect of the invention, the internal state vector depends on a previous value of the internal state vector and the current input value.

### BRIEF DESCRIPTION OF THE DRAWINGS

FIG. 1 illustrates the computational flow in the continuous computation of this cascade.

FIG. 2 illustrates the computational flow of a bi-quad in a state space model described by Equations (12)-(15).

FIG. 3 illustrates one embodiment of an apparatus for simulating a physical system according to the present invention.

### DETAILED DESCRIPTION

The present invention is based on the observation that lightly damped resonances in state space models can be modeled using bi-quadratic functions. Such functions can reproduce a resonance over a limited band of frequencies without coupling significant energy from frequency bands outside far from the resonance into the resonance or exciting other resonances through the “tails” of the function. Hence, noise that is not in the frequency band of the resonance does not produce the problems discussed above. In addition, the bi-quadratic functions can be used to model non-resonance behavior.

For a continuous time physical system, the system receives inputs represented by a vector, u(t), and generates outputs represented by a vector, y(t). The system has internal states represented by a vector, x(t). The model is represented by four matrices, F, G, H, and D, and a set of equations

\dot{x}(t)=Fx(t)+Gu(t)

v(t)=Hx(t)+Du(t) (1)

where \dot{x}(t), is the derivative of x(t) with respect to t. In this example, it is assumed that the matrices are time invariant; however, this need not be the case. To simplify the following discussion, it will be assumed that the matrices are time invariant. The details of the specific physical system are “buried” in the matrices. It should be noted that x(t) and y(t) are vectors.

To implement such a model on a computer, a discrete system in which the inputs and outputs are measured at discrete time intervals is implemented. It can be shown that the continuous time equations discussed above are equivalent to

x(k+1)=F_{D}x(k)+G_{D}u(k)

y(k)=H_{D}x(k)+D_{D}u(k) (2)

Here F_{D}, G_{D}, H_{D}, and D_{D} are the discrete equivalents of the matrices F, G, H, and D discussed above. Equations (2) are the standard textbook predictive form for the space state models. The manner in which these matrices are determined will be discussed in more detail below.

It should be noted that the state space equations depend on the internal state x(k). There are usually a number of candidates for the internal state, and depending on the choice of candidate, the state space equations may be different. For example, if one defines an internal state d(k)=x(k+1), then the equivalent state space equations become

d(k)=F_{D}d(k−1)+G_{D}u(k)

y(k)=H_{D}d(k−1)+D_{D}u(k) (3)

This is the form of the state space equations that is used to emulate filters in signal processing applications. To simplify the following discussion, the form of the state space equations given in Equations (2) will be assumed. However, any state space equations that can be obtained by making a different choice of internal state variable in Equations (2) will be defined to be equivalent to Equations (2).

The present invention is based on the observation that a system that is represented by components having a bi-quadratic transfer function can be used to simulate a system having one or more lightly damped system components as well as other components. To simplify the following discussion, a component that has a bi-quadratic transfer function will be referred to as a “bi-quad”. A bi-quad has at most two poles and two zeros. By the correct placement of the poles and zeros, the component can either simulate an anti-resonance or a resonance. Consider a continuous time bi-quad having a transfer function:

$$H ( s ) = K ( \frac{{s}^{2} + 2 {ζ}_{n} {ω}_{n} s + {ω}_{n}^{2}}{{s}^{2} + 2 {ζ}_{d} {ω}_{d} s + {ω}_{d}^{2}} ) \qquad ( 4 )$$

The state space equations for this component can be represented in a two-step differential form as:

\ddot{d}+2ζ_{d}ω_{d}\dot{d}+ω_{d}²=u

y=K(\ddot{d}+2ζₙωₙ\dot{d}+ωₙ²d) (5)

This can be represented in state space form as:

$$[ \begin{matrix}\ddot{d} \\ \dot{d}\end{matrix} ] = [ \begin{matrix}- 2 {ζ}_{d} {ω}_{d} & - {ω}_{d}^{2} \\ 1 & 0\end{matrix} ] [ \begin{matrix}\dot{d} \\ d\end{matrix} ] + [ \begin{matrix}1 \\ 0\end{matrix} ] u \\ and \\ y = [ K ( 2 {ζ}_{n} {ω}_{n} - 2 {ζ}_{d} {ω}_{d} ) K ( {ω}_{n}^{2} - {ω}_{d}^{2} ) ] [ \begin{matrix}\dot{d} \\ d\end{matrix} ] + [ \begin{matrix}K \\ 0\end{matrix} ] u \qquad ( 6 )$$

In the case where |ζ_{d}|<1, the behavior of the denominator will be oscillatory, and thus ω_{d} can be considered the undamped natural frequency of the denominator roots (poles), corresponding to the distance on the s plane from the s=0 point. Likewise, in the case where |ζ_{d}|<1, the behavior of the denominator will be oscillatory, and thus ωₙ can be considered the undamped natural frequency of the numerator roots (zeros), corresponding to the distance on the s plane from the s=0 point. In any event, ω_{d}, ωₙ, ζ_{d}, and ζₙ determine the shape of the biquad response.

Many systems of interest will require more than one bi-quad to model the system's behavior. In a serially cascaded multi-bi-quad system, the output of one bi-quad becomes the input to the next bi-quad. To simplify the notation, the transfer function for the bi-quad in a multi-bi-quad representation will be written as

$${H}_{1} ( s ) = ( \frac{{b}_{i 0} {s}^{2} + {b}_{i 1} s + {b}_{i 2}}{{s}^{2} + {a}_{i 1} s + {a}_{i 2}} ) \qquad ( 7 )$$

It should be noted that one or more of the coefficients, bᵢⱼ and aᵢⱼ, could be zero. Hence, the bi-quad can also model behavior that is not resonant or anti-resonant, including first order models.

A cascade of three bi-quads would then have the transfer function

$${H}_{1} ( s ) = ( \frac{{b}_{00} {s}^{2} + {b}_{01} s + {b}_{02}}{{s}^{2} + {a}_{01} s + {a}_{02}} ) ( \frac{{b}_{10} {s}^{2} + {b}_{11} s + {b}_{12}}{{s}^{2} + {a}_{11} s + {a}_{12}} ) ( \frac{{b}_{20} {s}^{2} + {b}_{21} s + {b}_{22}}{{s}^{2} + {a}_{21} s + {a}_{22}} ) , \qquad ( 8 )$$

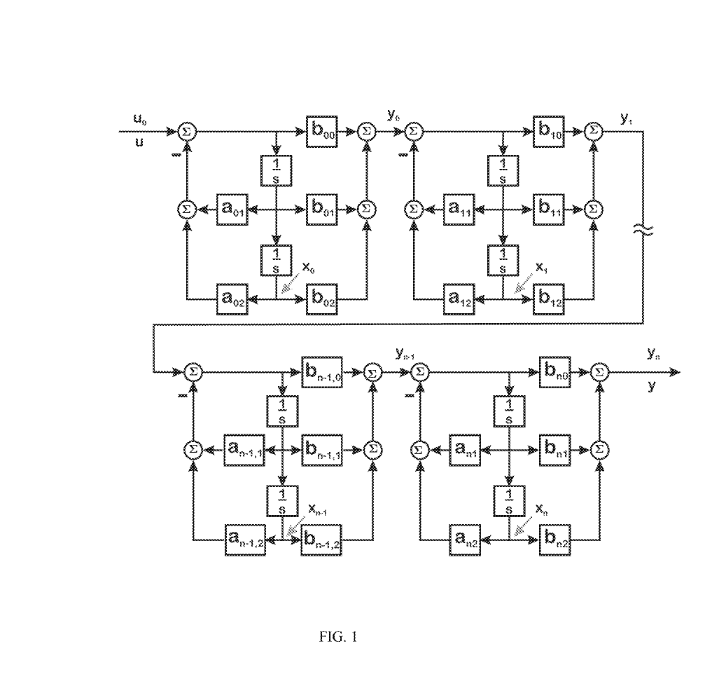

The computational flow in the continuous computation of this cascade is shown in FIG. 1. The general form of continuous time linear state equation is:

\dot{X}=FX+Gu

and

Y=HX+Du, (9)

Define the vectors X and Y as follows:

$$X = [ \begin{matrix}{\dot{x}}_{2} \\ {x}_{2} \\ {\dot{x}}_{1} \\ {x}_{1} \\ {\dot{x}}_{0} \\ {x}_{0}\end{matrix} ] , \dot{X} = [ \begin{matrix}{\ddot{x}}_{2} \\ {\dot{x}}_{2} \\ {\ddot{x}}_{1} \\ {\dot{x}}_{1} \\ {\ddot{x}}_{0} \\ {\dot{x}}_{0}\end{matrix} ] , and Y = [ \begin{matrix}{y}_{2} \\ {y}_{1} \\ {y}_{0}\end{matrix} ] . \qquad ( 10 )$$

Then, it can be shown that the matrices F, G, H, and D are given by

$$F = [ \begin{matrix}- {a}_{21} & - {a}_{22} & ( {b}_{11} - {a}_{11} {b}_{10} ) & ( {b}_{12} - {a}_{12} {b}_{10} ) & {b}_{10} ( {b}_{01} - {a}_{01} {b}_{00} ) & {b}_{10} ( {b}_{02} - {a}_{02} {b}_{00} ) \\ 1 & 0 & 0 & 0 & 0 & 0 \\ 0 & 0 & - {a}_{11} & - {a}_{12} & ( {b}_{01} - {a}_{01} {b}_{00} ) & ( {b}_{02} - {a}_{02} {b}_{00} ) \\ 0 & 0 & 1 & 0 & 0 & 0 \\ 0 & 0 & 0 & 0 & - {a}_{01} & - {a}_{02} \\ 0 & 0 & 0 & 0 & 1 & 0\end{matrix} ] . \\ G = [ \begin{matrix}{b}_{10} {b}_{00} \\ 0 \\ {b}_{00} \\ 0 \\ 1 \\ 0\end{matrix} ] \\ H = [ \begin{matrix}( \begin{matrix}{b}_{21} - \\ {a}_{21} {b}_{20}\end{matrix} ) & ( \begin{matrix}{b}_{22} - \\ {a}_{22} {b}_{20}\end{matrix} ) & {b}_{20} ( \begin{matrix}{b}_{11} - \\ {a}_{11} {b}_{10}\end{matrix} ) & {b}_{20} ( \begin{matrix}{b}_{12} - \\ {a}_{12} {b}_{10}\end{matrix} ) & {b}_{20} {b}_{10} ( \begin{matrix}{b}_{01} - \\ {a}_{01} {b}_{00}\end{matrix} ) & {b}_{20} {b}_{10} ( \begin{matrix}{b}_{02} - \\ {a}_{02} {b}_{00}\end{matrix} ) \\ 0 & 0 & ( {b}_{11} - {a}_{11} {b}_{10} ) & ( \begin{matrix}{b}_{12} - \\ {a}_{12} {b}_{10}\end{matrix} ) & {b}_{10} ( \begin{matrix}{b}_{01} - \\ {a}_{01} {b}_{00}\end{matrix} ) & {b}_{10} ( \begin{matrix}{b}_{02} - \\ {a}_{02} {b}_{00}\end{matrix} ) \\ 0 & 0 & 0 & 0 & ( \begin{matrix}{b}_{01} - \\ {a}_{01} {b}_{00}\end{matrix} ) & ( \begin{matrix}{b}_{02} - \\ {a}_{02} {b}_{00}\end{matrix} )\end{matrix} ] \\ D = [ \begin{matrix}{b}_{20} {b}_{10} {b}_{00} \\ {b}_{10} {b}_{00} \\ {b}_{00}\end{matrix} ] . \qquad ( 11 )$$

In practice, a discrete time bi-quad system is utilized when computing the simulation on a data processing system. The matrix structure of the discrete bi-quad components and strings of bi-quads is the same as that discussed above for the continuous time state space models; however, the physical interpretation of the coefficients is different. For a cascade of three bi-quads, the discrete transfer function has the form:

$${H}_{1} ( z ) = ( \frac{{b}_{00} + {b}_{01} {z}^{- 1} + {b}_{02} {z}^{- 2}}{1 + {a}_{01} {z}^{- 1} + {a}_{02} {z}^{- 2}} ) ( \frac{{b}_{10} + {b}_{11} {z}^{- 1} + {b}_{12} {z}^{- 2}}{1 + {a}_{11} {z}^{- 1} + {a}_{12} {z}^{- 2}} ) ( \frac{{b}_{20} + {b}_{21} {z}^{- 1} + {b}_{22} {z}^{- 2}}{1 + {a}_{21} {z}^{- 1} + {a}_{22} {z}^{- 2}} ) \qquad ( 12 )$$

The general form of the discrete time, linear state equation is:

$$\begin{matrix}X ( k + 1 ) = {F}_{D} X ( k ) + {G}_{D} u ( k ) \\ and \\ Y ( k ) = {H}_{D} X ( k ) + {D}_{D} u ( k ) , \\ where , & ( 13 ) \\ X ( k + 1 ) = [ \begin{matrix}{x}_{2} ( k + 1 ) \\ {x}_{2} ( k ) \\ {x}_{1} ( k + 1 ) \\ {x}_{1} ( k ) \\ {x}_{0} ( k + 1 ) \\ {x}_{0} ( k )\end{matrix} ] , X ( k ) = [ \begin{matrix}{x}_{2} ( k ) \\ {x}_{2} ( k - 1 ) \\ {x}_{1} ( k ) \\ {x}_{1} ( k - 1 ) \\ {x}_{0} ( k ) \\ {x}_{0} ( k - 1 )\end{matrix} ] , \\ and Y ( k ) = [ \begin{matrix}{y}_{2} ( k ) \\ {y}_{1} ( k ) \\ {y}_{0} ( k )\end{matrix} ] . & ( 14 )\end{matrix}$$

For these definitions, it can be shown that

$${F}_{D} = [ \begin{matrix}- {a}_{21} & - {a}_{22} & ( {b}_{11} - {a}_{11} {b}_{10} ) & ( {b}_{12} - {a}_{12} {b}_{10} ) & {b}_{10} ( {b}_{01} - {a}_{01} {b}_{00} ) & {b}_{10} ( {b}_{02} - {a}_{02} {b}_{00} ) \\ 1 & 0 & 0 & 0 & 0 & 0 \\ 0 & 0 & - {a}_{11} & - {a}_{12} & ( {b}_{01} - {a}_{01} {b}_{00} ) & ( {b}_{02} - {a}_{02} {b}_{00} ) \\ 0 & 0 & 1 & 0 & 0 & 0 \\ 0 & 0 & 0 & 0 & - {a}_{01} & - {a}_{02} \\ 0 & 0 & 0 & 0 & 1 & 0\end{matrix} ] . \\ {G}_{D} = [ \begin{matrix}{b}_{10} {b}_{00} \\ 0 \\ {b}_{00} \\ 0 \\ 1 \\ 0\end{matrix} ] \\ {H}_{D} = [ \begin{matrix}( \begin{matrix}{b}_{21} - \\ {a}_{21} {b}_{20}\end{matrix} ) & ( \begin{matrix}{b}_{22} - \\ {a}_{22} {b}_{20}\end{matrix} ) & {b}_{20} ( \begin{matrix}{b}_{11} - \\ {a}_{11} {b}_{10}\end{matrix} ) & {b}_{20} ( \begin{matrix}{b}_{12} - \\ {a}_{12} {b}_{10}\end{matrix} ) & {b}_{20} {b}_{10} ( \begin{matrix}{b}_{01} - \\ {a}_{01} {b}_{00}\end{matrix} ) & {b}_{20} {b}_{10} ( \begin{matrix}{b}_{02} - \\ {a}_{02} {b}_{00}\end{matrix} ) \\ 0 & 0 & ( {b}_{11} - {a}_{11} {b}_{10} ) & ( \begin{matrix}{b}_{12} - \\ {a}_{12} {b}_{10}\end{matrix} ) & {b}_{10} ( \begin{matrix}{b}_{01} - \\ {a}_{01} {b}_{00}\end{matrix} ) & {b}_{10} ( \begin{matrix}{b}_{02} - \\ {a}_{02} {b}_{00}\end{matrix} ) \\ 0 & 0 & 0 & 0 & ( \begin{matrix}{b}_{01} - \\ {a}_{01} {b}_{00}\end{matrix} ) & ( \begin{matrix}{b}_{02} - \\ {a}_{02} {b}_{00}\end{matrix} )\end{matrix} ] \\ {D}_{D} = [ \begin{matrix}{b}_{20} {b}_{10} {b}_{00} \\ {b}_{10} {b}_{00} \\ {b}_{00}\end{matrix} ] . \qquad ( 15 )$$

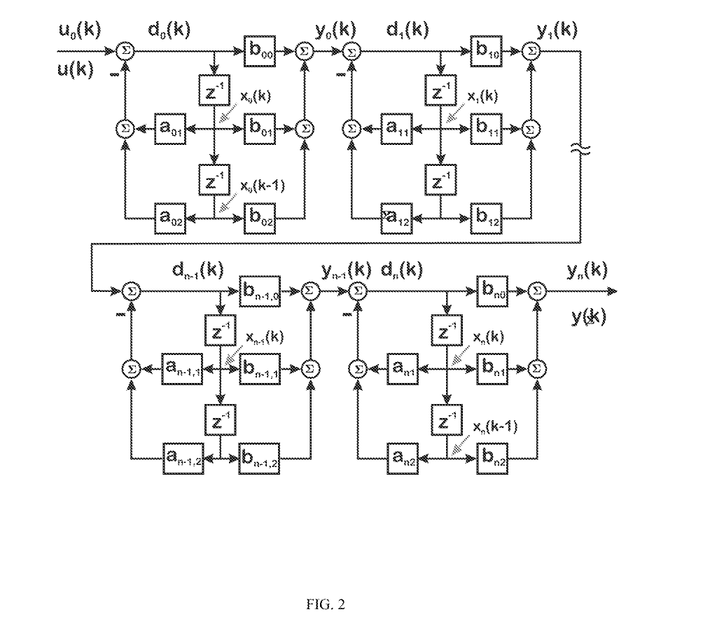

Refer now to FIG. 2, which illustrates the computational flow of a bi-quad in a state space model described by Equations (12)-(15). As noted above, by redefining the state vector in terms dᵢ(k)=xᵢ(k+1), an equivalent set of state equations and matrices can be derived.

The manner in which a bi-quad cascade according to the present invention is used to model a system will now be discussed in more detail. For any given number of bi-quads in the cascade, a state space model having matrices and vectors analogous to those discussed above can be constructed. In general, that model will have 5N free parameters, where N is the number of bi-quads in the model. The free parameters are the aᵢⱼ and bᵢⱼ discussed above. In one aspect of the invention, the free parameters are determined by fitting the experimentally observed outputs as a function of the inputs of the system being modeled using a least squares or other fitting algorithms. Such algorithms are known in the art, and hence, will not be discussed in detail.

In one aspect of the invention, the number of bi-quads in the model starts at one and is increased until the addition of another bi-quad does not significantly improve the model as judged by the least squares fitting algorithm. Consider the residual error in the least squares fitting process after the best fit for the number of free parameters has been found. That residual error is a function of the number of bi-quads in the model. Typically, the residual error decreases with N until some minimum value is obtained. After that N, the model does not typically improve by increasing N.

The above-described fitting process does not place any separate constraints on the free parameters of the model. As noted above, the five coefficients that characterize each bi-quad are related to the frequency and damping factors of a resonance and an anti-resonance in the transfer function. If the system being modeled has known resonances and/or anti-resonances, the parameters of one or more of the bi-quad can be constrained to match the frequencies and damping factors of these known resonances or anti-resonances. The constraint can be exact or specify a range around the known values in which the fitted parameters must remain.

Each bi-quad represents both a resonance and anti-resonance. Consider a system having a number of resonances and anti-resonances. In particular, consider a bi-quad that is matched to a particular one of these resonances. That bi-quad's anti-resonance could, in principle, be matched to any of the anti-resonances in the model. By making a particular choice for the anti-resonance, sensitivity of the model to noise can be improved.

In general, a bi-quad will contribute significant energy to the system response at frequencies between the frequencies of the resonance and anti-resonance and to some extent above and below these frequencies depending on the damping factors of the resonance and anti-resonance. The frequency range over which a given bi-quad provides significant energy in the model will be referred to as that bi-quad's frequency band. Ideally, noise in the frequency band of one bi-quad should not have a significant effect on the parameters of a different bi-quad. If the frequency bands of the bi-quads do not overlap in a region in which one of the bi-quads contributes significant energy to the model, this condition will be met. However, if the frequency bands of the bi-quads overlap, then noise in the region of the overlap will impact both bi-quads, and the fit will be more sensitive to noise.

In one aspect of the invention, the system anti-resonance chosen to match a particular resonance is the closest anti-resonance in frequency to the resonance in question. This has the effect of reducing the width of the bi-quad's frequency band, and hence, reducing the probability that the frequency band of one bi-quad significantly overlaps the frequency band of another bi-quad.

The bi-quad model of the present invention can be combined with models dealing with aspects of the system that are not well modeled by just a cascade of bi-quads. In such a scheme, the system being modeled is considered to be composed of two components, one that is modeled by a cascade of bi-quads and one that is represented by a different form of transfer function defined by another set of free parameters. If the second component can be represented by a state space model that satisfies state space equations analogous to those that describe the bi-quad model, then a combined state space representation can be generated in a manner analogous to that described above for combining a number of bi-quad components. For example, consider the case in which the bi-quad model satisfies Equations (2) discussed above, and the second component is also described by a set of equations in the form of Equations (2), but with different matrices, inputs, outputs, and state variables. Then the two models can be combined by extending the state vectors of the bi-quad model to include the states of the second component and coupling the output of the bi-quad model to the inputs of the second component. A new set of matrices can then be derived from the individual model equations.

For example, consider a model for a system that includes a solid mass that moves under forces generated by an input to the component. One method for generating a model to simulate a rigid body utilizes a double integration of Newton's Law, ƒ=ma=m\ddot{x}. In the case where there are no resonances in the model, the continuous state space equations can be written in the form:

$$D ( s ) = \frac{1}{{ms}^{2}} = \frac{K}{{s}^{2}} , \\ [ \begin{matrix}\ddot{d} \\ \dot{d}\end{matrix} ] = [ \begin{matrix}0 & 0 \\ 1 & 0\end{matrix} ] [ \begin{matrix}\dot{d} \\ d\end{matrix} ] + [ \begin{matrix}1 \\ 0\end{matrix} ] u and y = \begin{matrix}[ 0 & K ]\end{matrix} [ \begin{matrix}\dot{d} \\ d\end{matrix} ]$$

Here, K is a constant that depends on the mass, and y is the position of the mass in the system in an appropriate coordinate system.

A number of discrete equivalent forms of this transfer function are known. These include the Zero-Order Hold (ZOH) equivalent form and the Trapezoidal Rule equivalent form. For the ZOH form,

$${D}_{z} ( {z}^{- 1} ) = K ( \frac{{T}^{2}}{2} ) \frac{{z}^{- 1} ( 1 + {z}^{- 1} )}{{( 1 - {z}^{- 1} )}^{2}} . \qquad ( 16 )$$

For the Trapezoidal Rule form,

$${D}_{T} ( {z}^{- 1} ) = {K ( \frac{T}{2} )}^{2} ( \frac{1 + {z}^{- 1}}{1 - {z}^{- 1}} ) . \qquad ( 17 )$$

Depending on the rule used, the state equations can be put in a form such as Equations (2) discussed above. For example, a Trapezoidal Rule-based state space form can be shown to be as follows:

$$[ \begin{matrix}x ( k + 1 ) \\ x ( k )\end{matrix} ] = [ \begin{matrix}2 & - 1 \\ 1 & 0\end{matrix} ] [ \begin{matrix}x ( k ) \\ x ( k - 1 )\end{matrix} ] + [ \begin{matrix}1 \\ 0\end{matrix} ] u ( k ) \\ and \\ y ( k ) = \begin{matrix}[ {KT}^{2} & 0 ]\end{matrix} [ \begin{matrix}x ( k ) \\ x ( k - 1 )\end{matrix} ] + [ \frac{{KT}^{2}}{4} ] u ( k ) . \qquad ( 18 )$$

The state space model in Equations (18) describes a mass in a non-resonant system. The output y(k) is related to the position of the mass in some predetermined coordinate system, and the input u(k) represents the force that is applied to that mass. The internal states x(k) can represent some other unmeasured state of the mass. It should be noted that the state space model in Equations (18) is a special case of a bi-quad, i.e., a bi-quad with constraints on the coefficients.

Consider a system that has a mass connected such that the mass has one or more resonances. The state space model in Equations (18) can be combined with a model having a cascade of bi-quads by connecting the output of the mass system, y(k) to one of the inputs of the bi-quad system, and the input of the mass system, u(k) to the output of one of the bi-quads. A new set of state space equations can then be derived in a manner analogous to that described above in combining a plurality of single bi-quads into a larger system.

For example, the force applied to the mass as a function may be given as an input to the system. The position of the mass excites one or more resonances of a system connected to the mass. That system, in turn, provides a directly measured output. The system would be modeled by setting the system input to u(k), the input to the first bi-quad to be a function of the mass position, y(k). The output of the first bi-quad could then be coupled to another bi-quad, and so on, to provide a model with multiple resonances. The output of the final bi-quad is then the system output, which is measured. The internal properties coefficients of the model are then to provide the best fit between known inputs and the measured output of the system.

The above example deals with combining a state space model of a mass to that of a system having multiple bi-quads. It should be noted that a mass is a special case of a bi-quad. There are other components that are not resonant, but which can also be represented by a bi-quad. However, the same methodology can be applied to provide a state space model for the combination of any component that has a stand alone state space model with a component that is described by one or more bi-quads even if that component is not represented by a bi-quad.

It should be noted that this model, once the coefficients are determined, has internal states that are not directly measured, but which are estimated by the model. For example, the position of the mass is not directly measured in the above example, however, it is determined by the model at each time point.

It should also be noted that the internal states of a system could be measured in some instances by including an appropriate sensor that measures the state directly. In general, in a complex system, the number of sensors that would be needed to monitor all of the internal states is too large to economically provide one sensor per state. If the model's prediction for that state matches the observed value, improving the system by including a sensor for that state is of little value. However, if the internal state is poorly predicted by the model due to the lack of sensitivity of the system output to that state, the system and the model can be improved by including a sensor in the system that monitors that state, and hence, provides another input to the model of the augmented system.

The method of the present invention can be practiced on any data processing system having sufficient computational capacity. If the model is being run in real time as part of a control system such as a feedback loop, the data processing system must be able to perform the updated computations for each new input sample in a time consistent with the requirements of the control system.

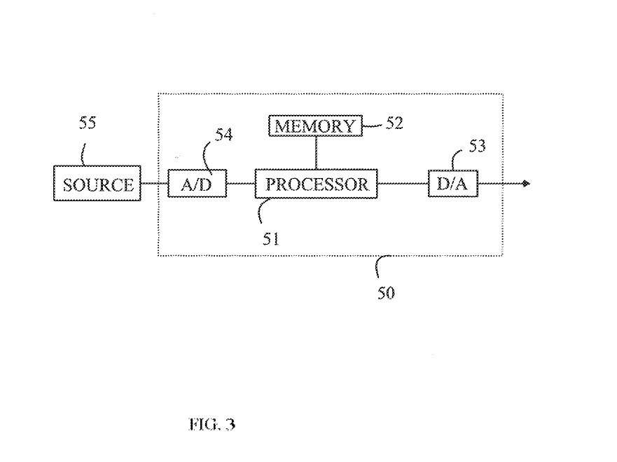

Refer now to FIG. 3, which illustrates one embodiment of an apparatus for simulating a physical system according to the present invention. Apparatus 50 processes an electric or optical signal from source 55. If source 55 provides an analog signal, the signal is digitized by A/D 54. If the source already produces a digital signal, A/D 54 can be omitted. A processor 51 computes the apparatus output from the state space model stored in a memory 52. Processor 51 can be implemented in special purpose signal processing hardware or as a conventional computational engine. Each time a new signal value is input to processor 51, processor 51 generates a digital output signal. If the desired output of apparatus 50 is an analog signal, an D/A converter 53 can be included in apparatus 50.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A method for operating a data processing system to simulate a physical system, said method comprising:
providing a model of said physical system, said model depending on values of a time-varying input and an internal state in said physical system, said internal state not being directly measurable, said model including a bi-quad that models a resonance or anti-resonance of said physical system; and
for each of a plurality of time points, receiving a current input value for said time-varying input, computing an internal state vector having a value of said internal state at a current time point as one component thereof and computing an estimate of a system output at that time point, said system output being directly measurable.

2. The method of claim 1 wherein said model comprises a plurality of bi-quads, each bi-quad being characterized by an input and an output, said input of one of said bi-quads being said output of another of said bi-quads.

3. The method of claim 2 wherein each of said bi-quads comprises a plurality of parameters that specify a frequency for a resonance and a frequency for an anti-resonance and wherein said parameters are determined by comparing said model's output for particular inputs to experimental data from said physical system with said inputs.

4. The method of claim 3 wherein said parameters are determined such that one of said bi-quads has a resonance or anti-resonance that matches a corresponding resonance or anti-resonance in said physical system.

5. The method of claim 3 wherein said physical system has a plurality of resonances and anti-resonances and wherein said parameters are chosen such that a bi-quad having a resonance that matches one of said physical system resonances has an anti-resonance that matches a physical system anti-resonance that is closed to that resonance.

6. The method of claim 1 wherein said internal state vector depends on a previous value of said internal state vector and said current input value.

7. The method of claim 1 further comprising outputting a value indicative of a component of said internal state vector at each time point.

8. The method of claim 1 wherein said model further includes a component that is not a bi-quad.

9. The method of claim 1 wherein said bi-quad models a moving mass.

10. The method of claim 1 wherein said model includes a state space model of a component that is not modeled by a bi-quad.

11. An apparatus that emulates a physical system, said apparatus comprising:
a data processing system that includes hardware and software that emulates said physical system, said software providing a model of said physical system, said model depending on values of a time-varying input and an internal state in said physical system, said internal state not being directly measurable, said model including a bi-quad that models a resonance or anti-resonance of said physical system; and
for each of a plurality of time points, said data processing system receiving a current input value for said time-varying input, computing an internal state vector having a value of said internal state at a current time point as one component thereof and computing an estimate of a system output at that time point, said system output being directly measurable.

12. The apparatus of claim 11 wherein said model comprises a plurality of bi-quads, each bi-quad being characterized by an input and an output, said input of one of said bi-quads being said output of another of said bi-quads.

13. The apparatus of claim 12 wherein each of said bi-quads comprises a plurality of parameters that specify a frequency for a resonance and a frequency for an anti-resonance and wherein said parameters are determined by comparing said model's output for particular inputs to experimental data from said physical system with said inputs.

14. The apparatus of claim 13 wherein said parameters are determined such that one of said bi-quads has a resonance or anti-resonance that matches a corresponding resonance or anti-resonance in said physical system.

15. The apparatus of claim 13 wherein said physical system has a plurality of resonances and anti-resonances and wherein said parameters are chosen such that a bi-quad having a resonance that matches one of said physical system resonances has an anti-resonance that matches a physical system anti-resonance that is closed to that resonance.

16. The apparatus of claim 11 wherein said internal state vector depends on a previous value of said internal state vector and said current input value.

17. The apparatus of claim 11 further comprising outputting a value indicative of a component of said internal state vector at each time point.

18. The apparatus of claim 11 wherein said model further includes a component that is not a bi-quad.

19. The apparatus of claim 11 wherein said bi-quad models a moving mass.

20. The apparatus of claim 11 wherein said model includes a state space model of a component that is not modeled by a bi-quad.
